(19) United States
(12) Patent Application Publication
(10) Pub. No.: US 2020/0166755 A1
(43) Pub. Date: May 28, 2020

(54) HEAD-MOUNTED DISPLAY

(71) Applicant: GREE, INC., Tokyo (JP)

(72) Inventor: Ken WATANABE, Tokyo (JP)

(21) Appl. No.: 16/631,734

(22) PCT Filed: Jun. 29, 2018
(86) PCT No.: PCT/JP2018/024907

§ 371 Date: Jan. 16, 2020

(30) Foreign Application Priority Data
Jul. 19, 2017 (JP) 2017-140071
Mar. 15, 2018 (JP) 2018-048547

(51) Int. Cl. G02B 27/01

(52) U.S. Cl. CPC G02B 27/0172; G02B 27/0176

(57) ABSTRACT

The present invention provides a head-mounted display using a reflective member, the head-mounted display enabling a user to maintain a sense of immersion, and achieving improvement in stability of a display device and the reflective member. This head-mounted display has: a holder part; a mount member which is configured to be mounted to the head of a user, and the length of which can be adjusted according to the size of the head; a display device in which a display surface for displaying an image is held by the holder part in such a manner as to face downward in a state where the mount member is mounted to the user's head; a reflective member in which a reflection surface is held by the holder part in such a manner as to face the display surface side of the display device, and which reflects an image toward the eyeballs of the user having the mount member mounted to the head thereof; and a shielding part which provides a shield for a space in which the display device and the reflective member are disposed.

### FIELD

The present disclosure relates to a head mounted display.

### BACKGROUND

In recent years, VR head mounted displays compatible with VR (Virtual Reality) are popular. The VR head mounted display is used in, e.g., games, sports, or live events performed in virtual reality. The VR head mounted display is mounted on the head of a user, detects the position or the orientation of the user, and displays an image corresponding to the detected position or orientation.

Such head mounted displays include a type having two display devices that display images different for right and left eyes, and a type having a single display device that displays one image common to the right and left eyes. Of such head mounted displays, especially in the latter head mounted display that involves both eyes in looking at one image, since the user looks at the same point on the single display device with his or her left and right eyes, he or she becomes cross-eyed and hard to view the display device. Therefore, in the latter head mounted display, the display device may be preferably placed at a certain distance from the positions of the eyeballs of the user.

Unfortunately, when the display device is placed in front of the head of the user at some distance from the positions of the eyeballs of the user to keep a larger distance from the eyeballs to the display device, the center of gravity of the head mounted display is located more to the front side. Especially when the user is a child whose head and neck still have insufficient muscular strengths, the user may preferably hold the head mounted display with his or her hands, and this problematically degrades a feeling of immersion.

PTL 1 discloses a hat-type virtual reality display video system having a video display provided in a mounting hole formed in the upper surface of the visor of a hat, and having a reflecting mirror that is provided on the lower surface of this visor and reflects video on the video display.

### CITATION LIST

### Patent Literature

### PTL 1: Japanese Unexamined Patent Publication (Kokai) No. 2017-89087

### SUMMARY

In the system disclosed in PTL 1, external video other than the video displayed on the video display is captured in the eyes of the user. Therefore, this system is unsuitable for use in a system that may preferably cause the user to visually recognize only the video displayed on the video display. In this system, furthermore, since the video display is provided in the mounting hole formed in the upper surface of the visor of the hat while the reflecting mirror is provided on the lower surface of the visor of the hat, the stability of the video display and the reflecting mirror may be impaired.

This embodiment has been made to solve such a problem, and has as its object to, in a head mounted display using a reflecting member, maintain a feeling of immersion for the user and improve the stability of a display device and the reflecting member.

The head mounted display according to an embodiment includes a holding portion, a mounting member mounted on a head of a user and adjusted in length in accordance with a size of the head, a display device held on the holding portion with a display surface, which displays an image, facing downwards in a state in which the mounting member is mounted on the head of the user, a reflecting member that is held on the holding portion with a reflecting surface facing the display surface of the display device, and reflects the image to an eyeball of the user having the mounting member mounted on the head, and a shielding portion that shields a space accommodating the display device and the reflecting member.

Preferably, in the above head mounted display, the reflecting member is placed in front of a face of the user equipped with the mounting member.

Preferably, in the above head mounted display, the reflecting member is held on the holding portion with a surface, opposite to the reflecting surface, abutting against the holding portion.

Preferably, in the above head mounted display, the display device is held in a portion of the holding portion, which is located above the head of the user equipped with the mounting member.

Preferably, in the above head mounted display, the shielding portion surrounds an occipital region of the user equipped with the mounting member.

Preferably, in the above head mounted display, the shielding portion covers a part of a side end of the mounting member.

Preferably, in the above head mounted display, the holding portion is provided with a weighting member for positioning a center of gravity of the head mounted display in a region located more to a parietal region of the user equipped with the mounting member than a portion holding the display device.

Preferably, in the above head mounted display, the head mounted display further includes a lens that is interposed between the display device and the reflecting member and magnifies the image.

Preferably, in the above head mounted display, the head mounted display further includes a sensor that acquires position and orientation information of a head mounted display. The display device displays an image corresponding to the position and orientation information.

The head mounted display according to an embodiment includes a holding portion, a display device including a display surface that displays an image, and a holding surface held on the holding portion, a reflecting member held on the holding portion with a reflecting surface facing the display surface of the display device, and a shielding portion that shields a space accommodating the display device and the reflecting member.

In this embodiment, in a head mounted display using a reflecting member, it is possible to maintain a feeling of immersion for the user and improve the stability of a display device and the reflecting member.

### BRIEF DESCRIPTION OF DRAWINGS

FIG. 1 is a view illustrating an exemplary schematic arrangement of a head mounted display 1.

FIGS. 2(A) and 2(B) are schematic perspective views illustrating the head mounted display 1.

FIG. 3 is a schematic perspective view illustrating the head mounted display 1.

FIG. 4(A) is a side view illustrating the head mounted display 1, and FIG. 4(B) is a front view illustrating the head mounted display 1.

FIGS. 5(A) and 5(B) are a plan view and a bottom view illustrating the head mounted display 1.

FIG. 6 is a schematic view for explaining the internal structure of the head mounted display 1.

FIG. 7 is a block diagram illustrating an exemplary schematic configuration of a control apparatus 2.

FIG. 8 is a schematic perspective view illustrating a head mounted display 3.

FIG. 9 is a schematic perspective view illustrating a head mounted display 4.

FIG. 10 is a schematic perspective view illustrating a head mounted display 5.

FIG. 11 is a view illustrating an exemplary schematic arrangement of a game system 100.

FIG. 12 is a view illustrating an exemplary schematic arrangement of a head mounted display 6.

### DESCRIPTION OF EMBODIMENTS

Various embodiments will be described below with reference to the drawings. However, it should be noted that the technical scope of the present disclosure is not limited to these embodiments and encompasses claims and its equivalents.

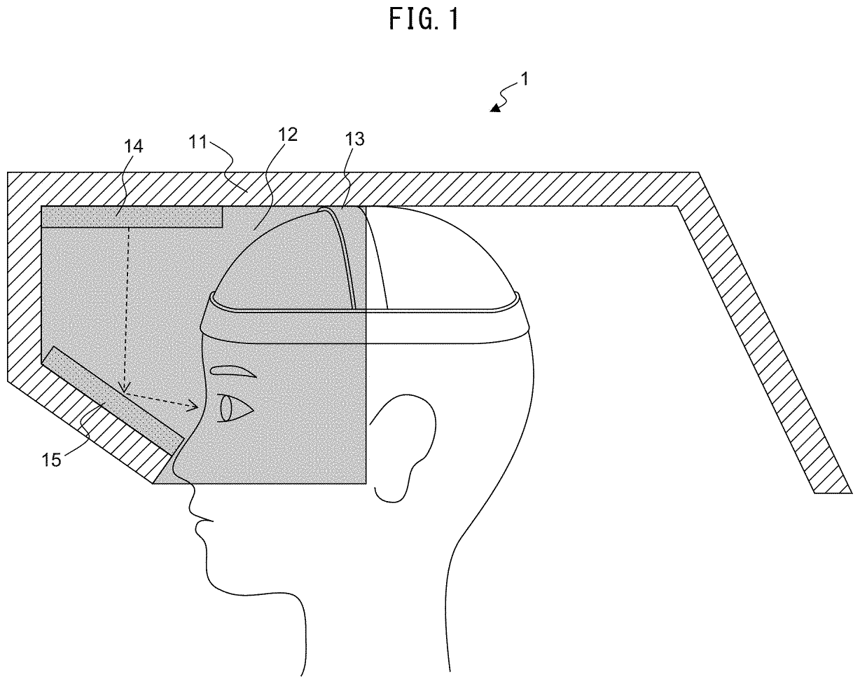

FIG. 1 is a view illustrating an exemplary schematic arrangement of a head mounted display 1.

The head mounted display 1 includes, e.g., a holding portion 11, shielding portions 12, a mounting member 13, a display device 14, and a reflecting member 15, as illustrated in FIG. 1.

The holding portion 11 holds inside the mounting member 13, the display device 14, and the reflecting member 15. The shielding portions 12 are provided on the holding portion 11 to shield a space, accommodating the display device 14 and the reflecting member 15, together with the holding portion 11. The mounting member 13 is mounted on the head of a user and held on the holding portion 11 to be adjusted in length in accordance with the size of this head. The display device 14 is held on the holding portion 11 with its display surface, which displays an image, facing downwards in the state in which the mounting member 13 is mounted on the head of the user. The reflecting member 15 is held on the holding portion 11 with its reflecting surface facing the display surface of the display device 14, and reflects the image displayed on the display device 14 to the eyeballs of the user.

In the head mounted display 1, since the holding portion 11 and the shielding portions 12 block external light, a feeling of immersion for the user can be maintained. In the head mounted display 1, furthermore, since the mounting member 13, the display device 14, and the reflecting member 15 are held inside one holding portion 11, the stability of the display device 14 and the reflecting member 15 with respect to the head of the user can be improved.

In the head mounted display 1, the size or the position of the rear end of the holding portion 11 is set (adjusted) so that its center of gravity falls within a certain range from the parietal region of the user and is preferably positioned near this parietal region. This makes it easy for the user to hold the head mounted display 1.

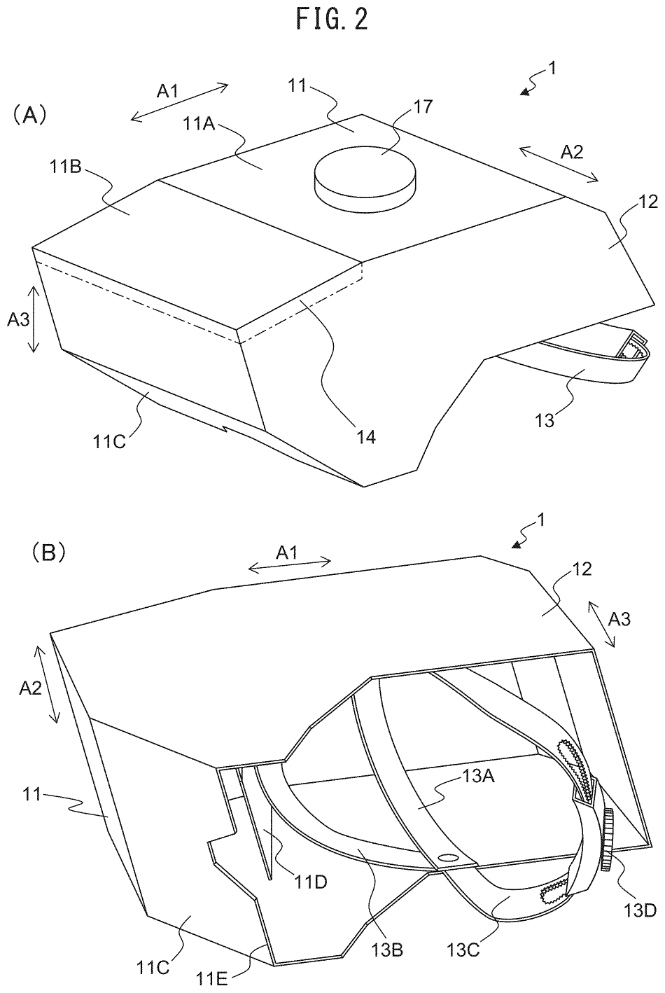

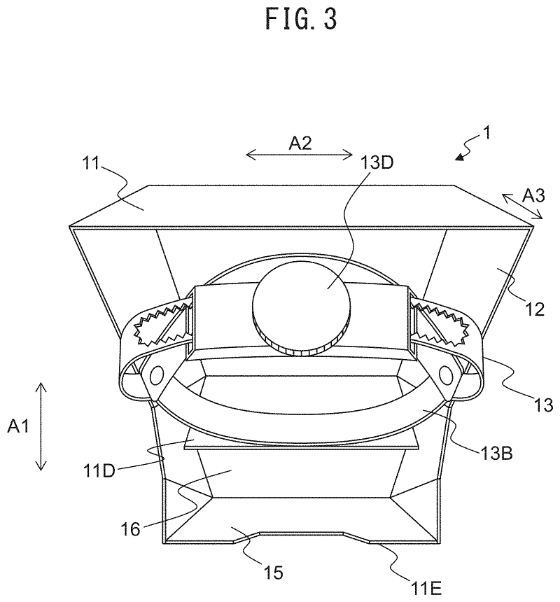

FIGS. 2(A), 2(B), and 3 are schematic perspective views illustrating the head mounted display 1 according to this embodiment. FIG. 2(A) is a perspective view of the head mounted display 1 as seen from obliquely above, FIG. 2(B) is a perspective view of the head mounted display 1 as seen from obliquely below, and FIG. 3 is a perspective view of the head mounted display 1 as seen from below.

The head mounted display 1 is implemented as a VR head mounted display that displays one image common to right and left eyes, and is used in, e.g., watching games, sports, or live events performed in virtual reality. The head mounted display 1 may even be used for purposes (e.g., general image viewing) other than VR. The head mounted display 1 includes, e.g., a holding portion 11, shielding portions 12, a mounting member 13, a display device 14, a reflecting member 15, a lens 16, and a sensor 17, as illustrated in FIGS. 2(A), 2(B), and 3.

The holding portion 11 is formed to cover the front area to the rear area of the head of the user equipped with the head mounted display 1, and holds inside, e.g., the mounting member 13, the display device 14, the reflecting member 15, and the lens 16. The holding portion 11 is formed by being bent to cover the head from the eyes of the user to his or her occipital region through his or her parietal region. The inner surface of the holding portion 11 has low reflectivity. The holding portion 11 is made of; e.g., a low-reflectivity material. The inner surface of the holding portion 11 may even be colored in black.

The holding portion 11 holds the mounting member 13 in a first portion 11A located at the center in a front-to-rear direction A1 and located on the upper side in a height direction A3. The holding portion 11 further holds the display device 14 in a second portion 11B (on the front side of the first portion 11A) located on the front side in the front-to-rear direction A1 and located on the upper side in the height direction A3. The second portion 11B is an example of a portion located above the head of the user equipped with the mounting member 13. The inner surface (second portion 11B) of the holding portion 11 may be provided with a mounting and removal mechanism for removably mounting the display device 14. The holding portion 11 further holds the reflecting member 15 in a third portion 11C (on the lower side of the second portion 11B) located on the front side in the front-to-rear direction A1 and located on the lower side in the height direction A3.

A support member 11D is provided inside the holding portion 11. The support member 11D is provided to extend downwards from the upper surface of the holding portion 11, and supports one end of the lens 16 on its one surface and the mounting member 13 on its other surface.

A rubber member or a cushioning member such as soft polyurethane foam may be provided at a lower end 11E of the third portion 11C. The lower end 11E of the third portion 11C is placed without contact with the face of the user. The rubber member can keep the head mounted display 1 clean, because even when the lower end 11E comes into contact with the face of the user, it is unlikely the user's sweat or sebum sticks to and gets stain on the member compared to a sponge member, etc. To prevent light from entering the head mounted display 1, the cushioning member may be provided to extend into the head mounted display 1 (to the face side of the user).

The shielding portions 12 are provided on the lateral sides of the holding portion 11 to cover the lateral areas of the head of the user equipped with the head mounted display 1. The inner surfaces of the shielding portions 12 have low reflectivity, like the inner surface of the holding portion 11. The shielding portions 12 are made of, e.g., a low-reflectivity material. The inner surfaces of the shielding portions 12 may even be colored in black. An opening is provided opposite to the first portion 11A of the holding portion 11 in a space formed by the holding portion 11 and the shielding portions 12, and the user can mount and remove the head mounted display 1 through the opening.

The mounting member 13 serves as a member for fixing the head of the user by being mounted on the head of the user. The mounting member 13 is held inside the first portion 11A of the holding portion 11, i.e., in the upper portion of the holding portion 11 to be mounted on the head of the user. The mounting member 13 includes a first mounting portion 13A mounted on the parietal region of the user, a second mounting portion 13B mounted on the forehead of the user, and a third mounting portion 13C mounted on the occipital region of the user, and is thus formed to be mounted on the forehead, the parietal region, and the occipital region of the user. The mounting member 13 further includes an adjustment dial 13D for adjusting the length of the third mounting portion 13C in accordance with the size of the head of the user. The user can appropriately fit the mounting member 13 onto his or her head by adjusting the length of the third mounting portion 13C using the adjustment dial 13D.

The mounting member 13 is formed by a rubber member or a resin member. Conventionally, a head mounted display of a type having a main body that abuts against the peripheries of the eyes of the user is mainly used. The head mounted display of this type is mounted on the head of the user by fastening a belt connected to the main body. In this case, to relax a pressure acting on the peripheries of the eyes of the user, a sponge member, etc., is provided at the position of contact with the user. However, since the mounting member 13 is mounted on the forehead, the parietal region, and the occipital region of the user, even when not a sponge member but a rubber member or a resin member is directly brought into contact with the user, the user does not feel as high a pressure as on the peripheries of his or her eyes. A rubber member or a resin member can keep the head mounted display 1 clean, because even when this member comes into contact with the face or the head of the user, it is unlikely the user's sweat or sebum sticks to and gets stain on the member compared to a sponge member, etc.

The display device 14 serves as a display that displays an image. The display device 14 includes a display surface that displays an image, and a holding surface held on the holding portion 11. In particular, the display device 14 is held inside the second portion 11B of the holding portion 11 and in front of the mounting member 13 to display an image in the inward (downward) direction of the holding portion 11. As the display device 14, a liquid crystal display or an organic EL (Electro-Luminescence) display, for example, is used. Alternatively, as the display device 14, a multifunctional mobile phone (so-called “smartphone”) or a tablet PC (Personal Computer), for example, may be used.

The reflecting member 15 is implemented as a mirror that is held on the holding portion 11 with its reflecting surface facing the display surface of the display device 14, and reflects the image displayed on the display device 14 to the eyeballs of the user having the mounting member 13 mounted on his or her head. The reflecting member 15 is held inside the third portion 11C of the holding portion 11, i.e., in the lower portion of the holding portion 11 to be placed in front of the face of the user equipped with the mounting member 13 and to face the display device 14. In other words, the reflecting member 15 is held on the holding portion 11 with its surface, opposite to its reflecting surface, abutting against the holding portion 11. As the reflecting member 15, a plastic mirror that causes little concern for breakage is preferably used. As the reflecting member 15, a paper mirror may also be used. Reflecting members 15 may even be provided in the optical paths from the display device 14 to the eyeballs of the user.

The lens 16 is interposed between the display device 14 and the reflecting member 15 and optically magnifies the image, displayed on the display device 14, when viewed from the side of the reflecting member 15. The lens 16 has its one end supported at the upper end of the third portion 11C, and its other end supported on the support member 11D. The lens 16 is implemented as, e.g., a convex Fresnel lens having a certain magnification (e.g., 6×). Lenses 16 may be interposed between the display device 14 and the reflecting member 15. One or more lenses may further be interposed between the reflecting member 15 and the eyeball positions of the user.

The sensor 17 serves as a position tracking device that acquires position or orientation information of the head mounted display 1. The sensor 17, for example, includes a light-receiver that receives a laser beam from a light-emitter that is provided outside and emits the laser beam, and calculates position information based on the light received by the light-receiver. The sensor 17 may include a three-axis acceleration sensor that detects an acceleration applied to the head mounted display 1 for each of three axial directions, and calculate position information of the head mounted display 1 from each acceleration detected by the three-axis acceleration sensor. The sensor 17 further includes a three-axis gyroscopic sensor that detects the rotational angular velocity of the head mounted display 1 for each of three axial directions, and calculates orientation information of the head mounted display 1 from each rotational angular velocity detected by the three-axis gyroscopic sensor. The sensor 17 may be of any type as long as it can acquire position or orientation information, and is not limited to the above-mentioned arrangement.

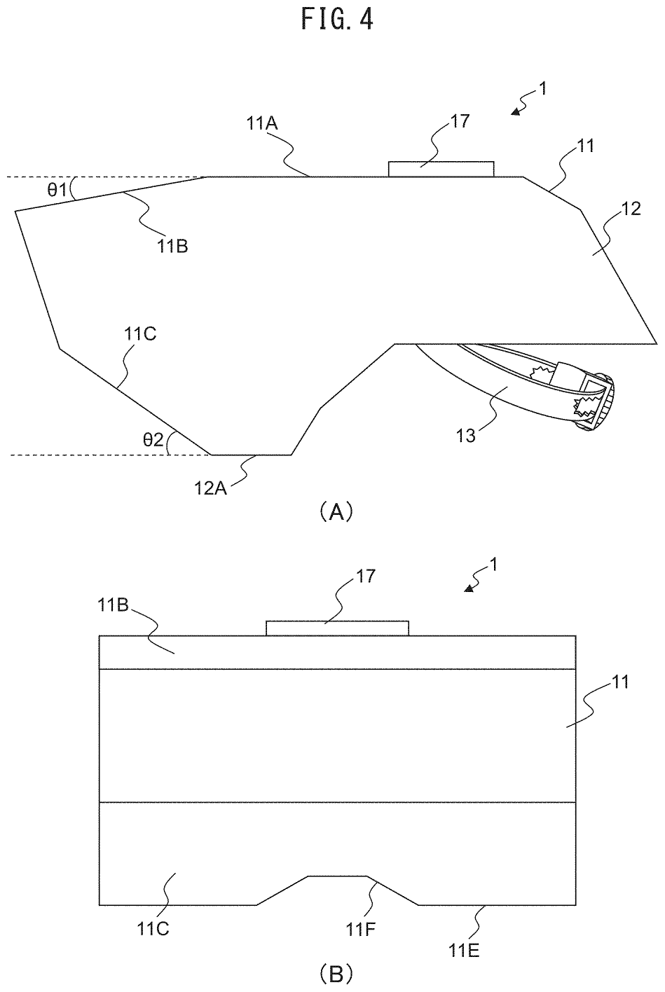

FIG. 4(A) is a side view illustrating the head mounted display 1.

The shielding portion 12 is formed with its upper end (its end in contact with the first portion 11A of the holding portion 11) and its lower end 12A extending nearly parallel to each other, as illustrated in FIG. 4(A). The head mounted display 1 is assumed to be used in the state in which the upper end and the lower end 12A of the shielding portion 12 are set nearly horizontal. The second portion 11B of the holding portion 11, i.e., the display device 14 is inclined downwards by a first angle θ1 with respect to the upper end of the shielding portion 12. The first angle θ1 is set to an angle (e.g., 10°) of 0° (exclusive) to 20° (exclusive). The third portion 11C of the holding portion 11, i.e., the reflecting member 15 is inclined upwards by a second angle θ2 with respect to the lower end 12A of the shielding portion 12. The second angle θ2 is set to an angle (e.g., 35°) of 30° (inclusive) to 50° (inclusive). In other words, the acute angle of the angles that a plane including the display surface of the display device 14 and a plane including the reflecting surface of the reflecting member 15 make with each other is set to 30° (exclusive) to 70° (exclusive), more preferably set to 40° (inclusive) to 60° (inclusive), and even more preferably set to 40° (inclusive) to 50° (inclusive).

The larger the second angle θ2 (the angle of elevation of the reflecting member 15), the smaller the size of the head mounted display 1 is, especially the space in front of the user, and then the center of gravity of the head mounted display 1 can be inhibited from shifting on the front side on which the display device 14, etc., are placed. However, if the second angle θ2 is set too large, the face of the user equipped with the head mounted display 1 may be captured in the reflecting member 15. Setting the first angle θ1 and the second angle θ2 in the above-mentioned way makes it possible to prevent the face of the user equipped with the head mounted display 1 from being captured in the reflecting member 15 while keeping down an increase in size of the head mounted display 1.

FIG. 4(B) is a front view illustrating the head mounted display 1.

A notched portion 11F is formed at the lower end 11E of the third portion 11C of the holding portion 11 to keep the nose of the user from touching the holding portion 11, as illustrated in FIG. 4(B).

To reflect the entire image displayed on the display device 14 by the reflecting member 15, the size of the reflecting member 15 may be preferably set larger for a larger distance between the reflecting member 15 and the eyeballs of the user equipped with the mounting member 13. The larger the size of the reflecting member 15, the larger the size of the head mounted display 1, especially the space in front of the user. Therefore, the distance between the reflecting member 15 and the eyeballs of the user equipped with the mounting member 13 is desirably set small. In the head mounted display 1, the use of the notched portion 11F allows a small distance between the reflecting member 15 and the eyeballs of the user equipped with the mounting member 13, and a small size of the head mounted display 1.

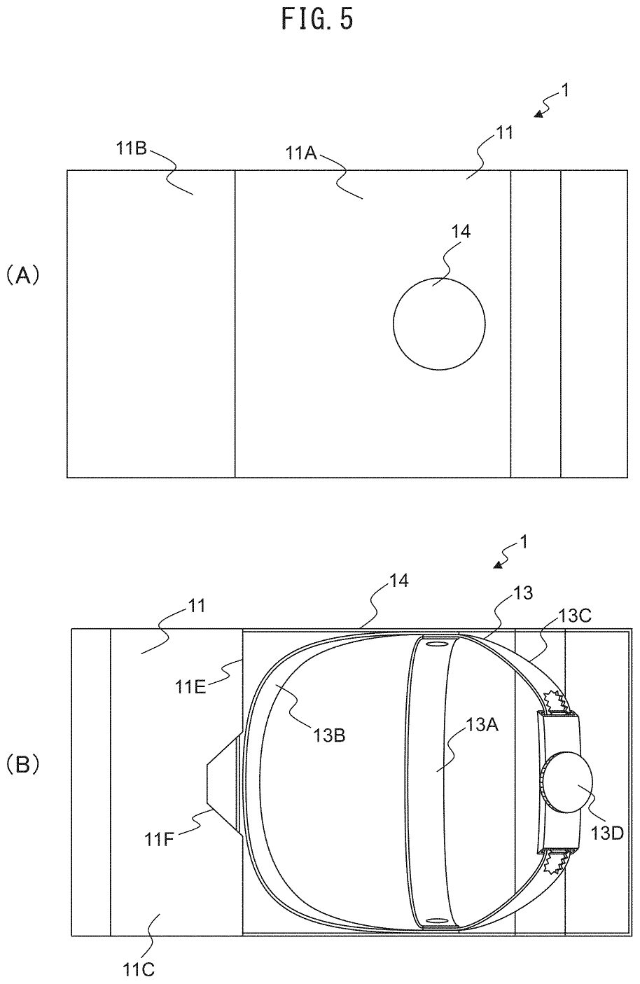

FIGS. 5(A) and 5(B) are a plan view and a bottom view, respectively, illustrating the head mounted display 1.

The sensor 17 is placed at a position opposite to the first mounting portion 13A of the mounting member 13 across the first portion 11A of the holding portion 11, as illustrated in FIGS. 5(A) and 5(B). With this arrangement, the sensor 17 can be placed at a position opposite to the parietal region of the user equipped with the head mounted display 1 to position the center of gravity of the head mounted display 1 closer to the parietal region of the user. Therefore, the user can easily hold the head mounted display 1.

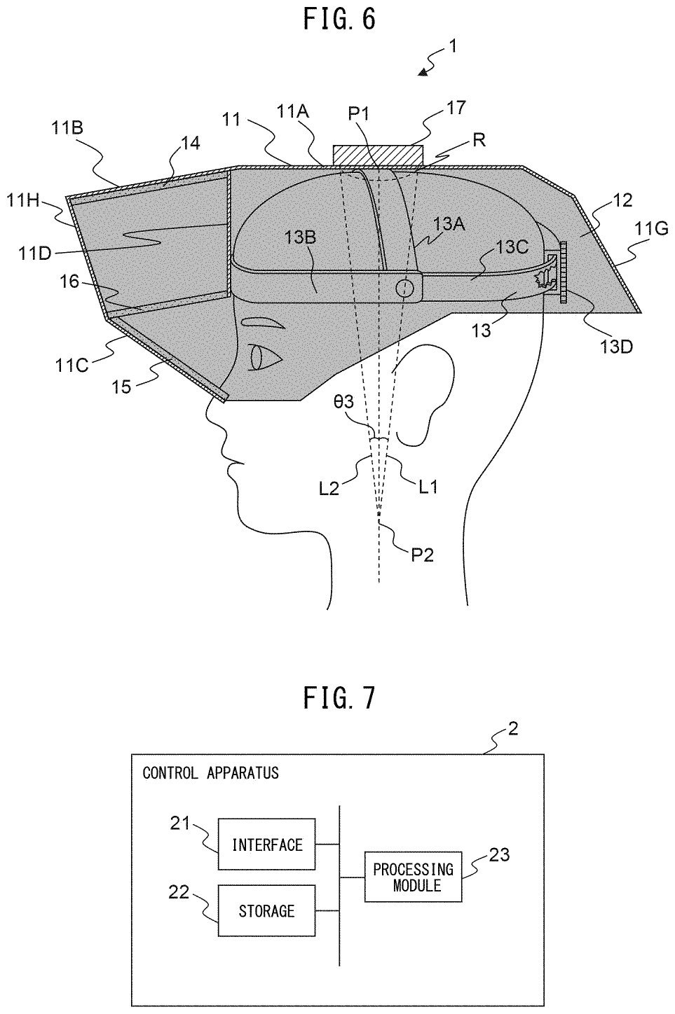

FIG. 6 is a schematic view for explaining the internal structure of the head mounted display 1.

As illustrated in FIG. 6, the display device 14 is placed to allow its display surface to display an image downwards, and the reflecting member 15 is placed with its reflecting surface facing the display surface of the display device 14, and to reflect the image displayed on the display device 14 to the eyeballs of the user equipped with the mounting member 13. The lens 16 is interposed between the display device 14 and the reflecting member 15 to optically magnify the image displayed on the display device 14 to the reflecting member 15. Therefore, the image displayed on the display device 14 is magnified by the lens 16, is reflected by the reflecting member 15, and reaches the eyes of the user.

In the head mounted display 1, the display device 14 is placed near or above the parietal region of the user equipped with the mounting member 13, with its display surface facing downwards. With this arrangement, in the head mounted display 1, the center of gravity of the head mounted display 1 can be positioned more to the rear side (the parietal region side of the user) by balancing the load of the display device 14 in a distributed manner, than when the display device 14 is placed in front of the eyeballs of the user in portrait mode with its display surface facing the face of the user. Therefore, the user can easily hold the head mounted display 1.

In the head mounted display 1, the image displayed on the display device 14 reaches the eyeballs of the user through the reflecting member 15. With this arrangement, the head mounted display 1 allows the image displayed on the display device 14 placed above the user to reach the eyeballs of the user. In the head mounted display 1, furthermore, the use of the reflecting member 15 sets the distance from the display position 14 to the eyes of the user equal to the sum of the distance from the display device 14 to the reflecting member 15 and that from the reflecting member 15 to the eyes of the user. Hence, in the head mounted display 1, the distance from the display device 14 to the eyes of the user can be set sufficiently large, and the user can thus be prevented from becoming cross-eyed and hard to view the display device 14.

In the head mounted display 1, the image displayed on the display device 14 reaches the eyeballs of the user through the lens 16. With this arrangement, in the head mounted display 1, the FOV (Field Of View) of video occupying the field of view of the user can be set wide without increasing the size of the display device 14. Hence, the head mounted display 1 can maintain a feeling of immersion for the user without increasing its size (weight).

In the head mounted display 1, the lens 16 may be omitted, and a magnifying glass may be used as the reflecting member 15 instead. Even in this case, the head mounted display 1 can maintain a feeling of immersion for the user.

The lens 16 is formed with its upper end (its end in contact with the first portion 11A of the holding portion 11) and its lower end 12A extending nearly parallel to each other. With this arrangement, the image displayed on the display device 14 is magnified without any distortion.

A half mirror that transmits light from the display device 14 and does not transmit light from the reflecting member 15 may be provided in the lower portion of the lens 16. This prevents external light from being reflected by the display device 14 and captured in the eyes of the user.

The holding portion 11 and the shielding portions 12 are formed to be flat (free from any projections) between the display device 14 and the lens 16 and between the lens 16 and the reflecting member 15. This prevents the image displayed on the display device 14 from being shielded and the holding portion 11 from being captured in the reflecting member 15.

In particular, in the holding portion 11, the support member 11D is provided perpendicularly to the first portion 11A. However, in the holding portion 11, a fourth portion 11H formed between the second portion 11B that holds the display device 14 and the third portion 11C that holds the reflecting member 15 has its upper side inclined forwards with respect to the support member 11D. With this arrangement, in the head mounted display 1, the size of the image captured in the field of view of the user can be set large while preventing the support member 11D and the fourth portion 11H located between the display device 14 and the lens 16 from being captured in the reflecting member 15.

The shielding portions 12 cover a part or the whole of the side ends of the mounting member 13, the display device 14, and the reflecting member 15, and shield a space, accommodating the display device 14 and the reflecting member 15, together with the holding portion 11. The shielding portions 12 surround the occipital region of the user equipped with the mounting member 13. With this arrangement, the shielding portions 12 block the entrance of external light into the head mounted display 1, especially to the eyeballs of the user equipped with the mounting member 13. Since the user looks at no image present outside the head mounted display 1, as equipped with the head mounted display 1, he or she can maintain a feeling of immersion in the image displayed on the display device 14.

The holding portion 11 is formed so that the center of gravity of the head mounted display 1 horizontally falls within a certain range R (e.g., 5 cm) from a parietal region P1 (the position at which the first mounting portion 13A abuts against the holding portion 11) of the user having the mounting member 13 mounted on his or her head, and is vertically located inside the head mounted display 1. Alternatively, the holding portion 11 may be formed so that the center of gravity of the head mounted display 1 horizontally falls within a certain range from the midpoint of two left and right connection positions P2 of the first mounting portion 13A, the second mounting portion 13B, and the third mounting portion 13C of the mounting member 13, and is vertically located inside the head mounted display 1.

In the head mounted display 1, the size or the position of a rear end 11G of the holding portion 11 is set (adjusted) so that its center of gravity falls within a certain range from the parietal region of the user. For example, in the head mounted display 1, the rear end 11G is formed to be large to ensure a balance between the front and rear sides with respect to the display device 14, the reflecting member 15, and the lens 16 arranged on the front side, assuming the parietal region of the user as a center. Alternatively, in the head mounted display 1, the rear end 11G may be formed on the rear side to ensure a balance between the front and rear sides. The rear end 11G of the holding portion 11 may even be provided with a weighting member for positioning the center of gravity of the head mounted display 1 in a region located more to the parietal region of the user (within a certain range from the parietal region of the user) equipped with the mounting member 13 than a portion holding the display device 14. As the weighting member, a voice output device such as a headphone that outputs a voice corresponding to the image displayed on the display device 14 may be provided at the rear end 11G of the holding portion 11. With these arrangements, the user can easily hold the head mounted display 1.

FIG. 7 is a block diagram illustrating an exemplary schematic configuration of a control apparatus 2.

The control apparatus 2 includes an interface 21, a storage 22, and a processing module 23. The control apparatus 2 is communicably connected to the sensor 17 and the display device 14, and changes the image to be displayed on the display device 14, in accordance with the detection result obtained by the sensor 17. The control apparatus 2 is connected to the sensor 17 and the display device 14 via a cable or a wireless communication network (neither is illustrated) and placed at a position distant from the head mounted display 1. The control apparatus 2 may be placed on the holding portion 11 of the head mounted display 1. When the display device 14 is implemented as, e.g., a multifunctional mobile phone or a tablet PC, the control apparatus 2 may be built into the display device 14.

The interface 21 includes an interface circuit based on a serial bus such as USB (Universal Serial Bus), and is electrically connected to the sensor 17 and the display device 14 to exchange images and various types of information with them. The interface 21 may further include an antenna that transmits and receives radio signals, and a wireless communication interface circuit for transmitting and receiving signals via a wireless communication channel in accordance with a certain communication protocol such as a wireless LAN (Local Area Network), and may be connected to the sensor 17 and the display device 14 by wireless communication.

The storage 22 includes, e.g., a semiconductor memory such as a volatile memory or a nonvolatile memory. The storage 22 stores, e.g., an operating system program, a driver program, an application program, and data used for processing by the processing module 23. A computer program may be installed in the storage 22 using, e.g., a known setup program from a computer-readable portable recording medium such as a CD-ROM (Compact Disc Read Only Memory) or a DVD-ROM (Digital Versatile Disc Read Only Memory). A computer program may even be installed in the storage 22 through wireless communication from, e.g., a specific server. The storage 22 stores, e.g., image (moving image or still image) data to be displayed on the display device 14 as the data. The storage 22 may further temporarily store temporary data associated with predetermined processing.

The processing module 23 includes one or more processors and their peripheral circuits. The processing module 23 is implemented as, e.g., a CPU (Central Processing Unit) and systematically controls the overall operation of the control apparatus 2. The processing module 23 may even be implemented as, e.g., a DSP (Digital Signal Processor), an LSI (Large Scale Integration), an ASIC (Application Specific Integrated Circuit), or an FPGA (Field-Programming Gate Array). The processing module 23 controls the operations of the interface 21, etc., to perform various types of processing of the control apparatus 2 in an appropriate sequence, based on, e.g., the programs stored in the storage 22. The processing module 23 performs the processing based on the programs (e.g., the operating system program, the driver program, and the application program) stored in the storage 22.

The processing module 23 obtains position information and orientation information of the head mounted display 1 from the sensor 17 via the interface 21. The processing module 23 reads out an image to be displayed on the display device 14 from the storage 22, and generates an image corresponding to the obtained position information and orientation information from the read image. The processing module 23 displays the generated image on the display device 14 via the interface 21. The processing module 23 generates a horizontally or vertically inverted image as appropriate so that the image displayed on the display device 14 is captured in the eyes of the user in a correct orientation.

As described above, in the head mounted display 1, since the holding portion 11 and the shielding portions 12 shield a space accommodating the display device 14 and the reflecting member 15 to block external light, a feeling of immersion for the user can be maintained. In the head mounted display 1, furthermore, since the mounting member 13, the display device 14, and the reflecting member 15 are held inside one holding portion 11, the stability of the display device 14 and the reflecting member 15 with respect to the head of the user can be improved.

In the head mounted display 1, the display device 14 is placed above the head of the user, and the image displayed on the display device 14 is reflected to the eyeballs of the user by the reflecting member 15. With this arrangement, the head mounted display 1 can have its center of gravity positioned on the rear side (the parietal region side of the user). Therefore, even when the user is a child, etc., whose head and neck still have insufficient muscular strengths, he or she can be equipped with the head mounted display 1 without holding the head mounted display 1 with his or her hands.

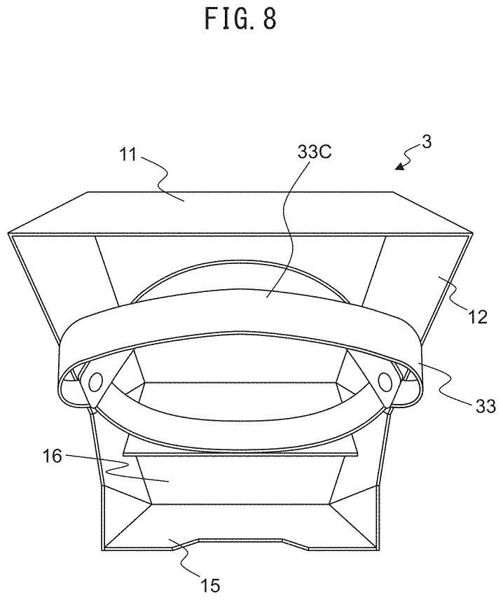

FIG. 8 is a schematic perspective view illustrating a head mounted display 3 according to another embodiment. FIG. 8 is a perspective view of the head mounted display 3 as seen from below.

The head mounted display 3 illustrated in FIG. 8 has an arrangement similar to that of the head mounted display 1. However, in the head mounted display 3, the adjustment dial 13D for adjusting the length of the third mounting portion 13C is omitted, and a third mounting member 33C is formed by an elastic member such as a rubber belt instead. With this arrangement, the user can appropriately fit a mounting member 33 onto his or her head using the elastic member. The head mounted display 3 can also produce an effect similar to that of the head mounted display 1.

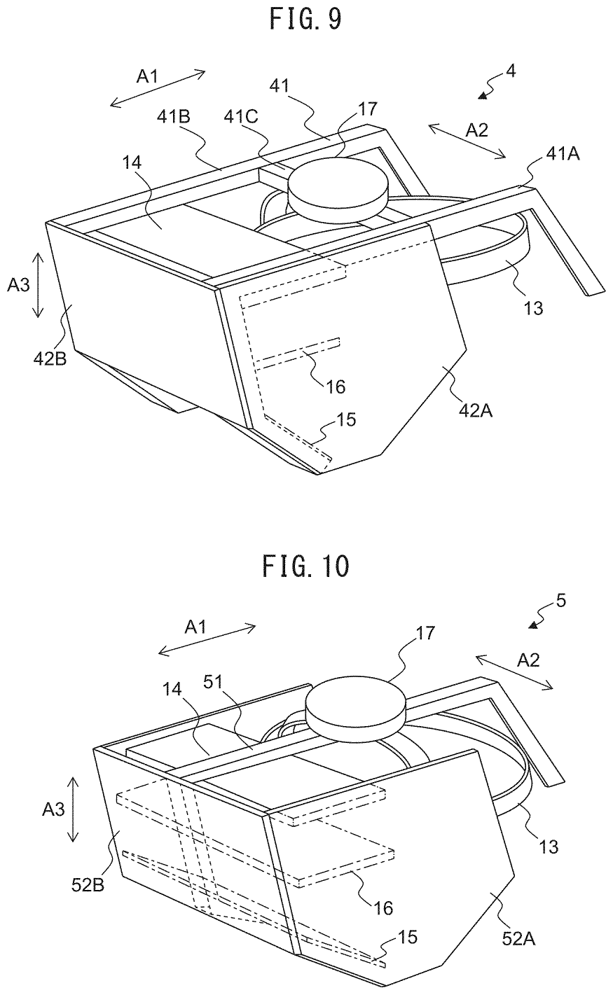

FIG. 9 is a schematic perspective view illustrating a head mounted display 4 according to still another embodiment. FIG. 9 is a perspective view of the head mounted display 4 as seen from obliquely above.

The head mounted display 4 illustrated in FIG. 9 has an arrangement similar to that of the head mounted display 1. However, in the head mounted display 4, the mounting member 13, the display device 14, the reflecting member 15, and the lens 16 are held by a bar-shaped holding portion 41 in place of the plate-shaped holding portion 11. The holding portion 41 includes a first portion 41A and a second portion 41B provided at the two ends in a right-to-left direction A2, and a third portion 41C that connects the first portion 41A to the second portion 41B. In the head mounted display 4, furthermore, shielding portions 42A that cover the lateral areas of the holding portion 41, and a shielding portion 42B that covers the front area of the holding portion 41 are provided in place of the shielding portions 12 that cover the lateral areas of the holding portion 11. The head mounted display 4 can also produce an effect similar to that of the head mounted display 1.

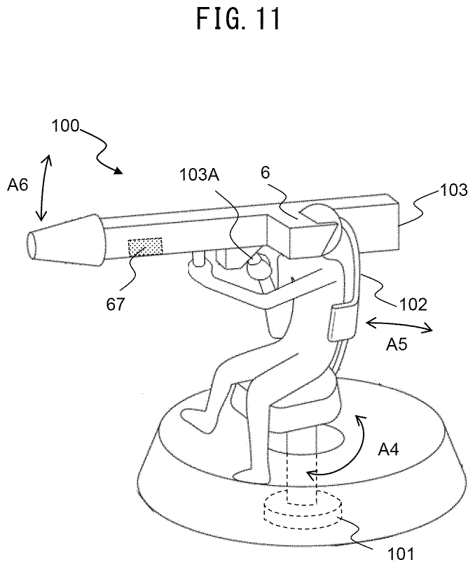

FIG. 10 is a schematic perspective view illustrating a head mounted display 5 according to still another embodiment. FIG. 10 is a perspective view of the head mounted display 5 as seen from obliquely above.

The head mounted display 5 illustrated in FIG. 10 has an arrangement similar to that of the head mounted display 1. However, in the head mounted display 5, the mounting member 13, the display device 14, the reflecting member 15, and the lens 16 are held by a bar-shaped holding portion 51 in place of the plate-shaped holding portion 11. The holding portion 51 is provided at the central position in the right-to-left direction A2. In the head mounted display 5, furthermore, shielding portions 52A that cover the lateral areas of the holding portion 51, and a shielding portion 52B that covers the front area of the holding portion 51 are provided in place of the shielding portions 12 that cover the lateral areas of the holding portion 11. The head mounted display 5 can also produce an effect similar to that of the head mounted display 1.

The present disclosure is not limited to this embodiment. For example, although an example in which the holding portion 11 and the shielding portions 12 are formed by separate members has been given in this embodiment, the holding portion 11 and the shielding portions 12 may be formed by the same member. For example, the holding portion 11 and the shielding portions 12 may form a part of a hat body mounted on the head of the user. The hat body has, e.g., a helmet shape.

A main body including the holding portion 11, the shielding portions 12, the display device 14, and the reflecting member 15 may be provided to be rotatable with respect to the mounting member 13. The main body, for example, accommodates the display device 14 and the reflecting member 15 in a space formed by the holding portion 11 and the shielding portions 12. The main body is connected to the mounting member 13 through a rotating shaft member to be rotatable in the elevation and depression angle direction with respect to the mounting member 13. This makes it possible to place the display device 14 and the reflecting member 15 at appropriate positions corresponding to user-specific individual differences.

FIG. 11 is a view illustrating an exemplary schematic arrangement of a game system 100 adopting a head mounted display 6 according to still another embodiment.

The game system 100 includes, e.g., a base 101, a chair 102, and an input device 103 in addition to the head mounted display 6, as illustrated in FIG. 11.

The base 101 is fixed to, e.g., a floor surface. The chair 102 allows a user who plays a game to sit in it, and is provided on the base 101 to be capable of swiveling in a horizontal direction A4. The input device 103 includes an operation device 103A that accepts an input operation by the user sitting in the chair 102, and is fixed to the chair 102 to rotate in the horizontal direction A4 upon swiveling of the chair 102 in the horizontal direction A4. The input device 103 is provided on the chair 102 to be movable (rotatable) in an elevation and depression angle direction A6 upon the reclining operation of the chair 102 in a front-to-rear direction A5.

A sensor 67 is provided on the input device 103, and acquires at least relative orientation information of the input device 103 with respect to a reference orientation in the swiveling direction (i.e., the horizontal direction A4) of the chair 102, and relative angle information of the input device 103 with respect to a reference angle in the elevation and depression angle direction A6. The reference orientation and the reference angle are set as the initial orientation and the initial angle of the input device 103 at a certain timing such as the start of a game.

The head mounted display 6 is provided on the input device 103 to face the user sitting in the chair, and displays an image corresponding to the relative orientation information and the relative angle information of the input device 103 acquired by the sensor 67, and the input operation by the user acquired by the operation device 103A. The input device 103 is an example of a mount portion to mount the head mounted display 6. The sensor 67 or the head mounted display 6 may calculate and obtain position information and orientation information of the head mounted display 6, from the relative orientation information and the relative angle information of the input device 103, based on the positional relationship between the mounting position of the sensor 67 and that of the head mounted display 6 set in advance. In this case, the head mounted display 6 displays an image corresponding to the position information and the orientation information of the head mounted display 6.

In the game system 100, the user changes the position and the orientation of the input device 103 by swiveling the chair 102 in the horizontal direction A4 with his or her foot force or reclining the chair 102 in the front-to-rear direction A5 with his or her back or waist force, while sitting in the chair 102. The changes in position and orientation of the input device 103 are detected by the sensor 67, and the image displayed on the head mounted display 6 changes in response to changes in orientation of the input device 103 in the horizontal direction and in angle of the input device 103 in the elevation and depression angle direction, i.e., changes in position and orientation of the head mounted display 6.

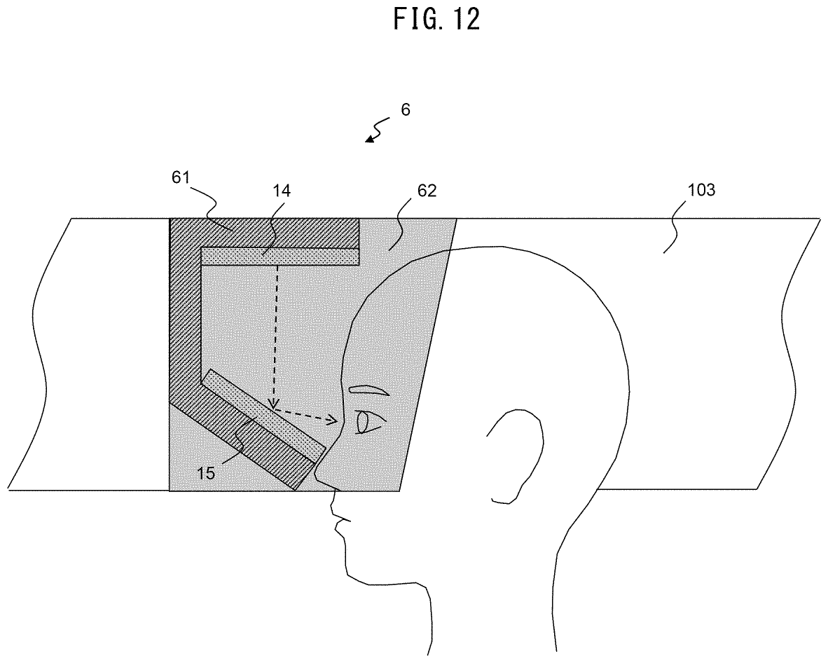

FIG. 12 is a view illustrating an exemplary schematic arrangement of the head mounted display 6.

The head mounted display 6 illustrated in FIG. 12 has an arrangement similar to that of the head mounted display 1. However, in the head mounted display 6, the mounting member 13 is omitted, and a holding portion 61 is fixed to the input device 103. In the head mounted display 6, furthermore, the display device 14 is held on the holding portion 11 with its display surface facing downwards, regardless of whether the head of the user is present in the head mounted display 6. The reflecting member 15 reflects the image displayed on the display surface of the display device 14 to the rear side of the head mounted display 6, i.e., in the direction in which the head of the user is positioned when the user sits in the chair, regardless of whether the head of the user is present in the head mounted display 6. In the head mounted display 6, the lateral area of the side of the input device 103 of the lateral areas of the holding portion 61 is shielded by the input device 103, and a shielding portion 62 is provided on the lateral side opposite to the input device 103. The user can visually recognize the image displayed on the head mounted display 6 fixed to the input device 103, by peering at the head mounted display 6.

The mount portion to mount the head mounted display is not limited to a cylindrical or columnar member that extends nearly horizontally and rotates nearly horizontally, like the input device 103. For example, the mount portion may be implemented as a wall of a movable room such as an elevator. Alternatively, the mount portion may be implemented as a cylindrical or columnar member that extends nearly vertically and is provided to be movable nearly vertically, like a periscope for monitoring the exterior of a submarine.

The head mounted display may be mounted to be movable with respect to the mount portion, instead of being fixed to the mount portion. For example, the head mounted display may be mounted on the mount portion through a rotating shaft to be rotatable with respect to the mount portion. Alternatively, the head mounted display may be mounted on the mount portion through a slide shaft to be slidable with respect to the mount portion. In this case, the sensor that acquires position information and orientation information of the head mounted display may be provided on the head mounted display to move upon movement of the head mounted display.

It should be understood that those skilled in the art may make various changes, substitutions, and modifications without departing from the spirit and scope of the present disclosure.

### REFERENCE SIGNS LIST

1, 3, 4, 5, 6 Head mounted display
11, 41, 51, 61 Holding portion
12, 42, 52, 62 Shielding portion
13, 33 Mounting member
14 Display device
15 Reflecting member
16 Lens
17, 67 Sensor

1. A head mounted display, comprising:
a holding portion;
a mounting member mounted on a head of a user and adjusted in length in accordance with a size of the head;
a display device having a display surface for displaying an image, the display device being held on the holding portion with the display surface facing downwards when the mounting member is mounted on the head of the user;
a reflecting member having a reflecting surface, the reflecting member being held on the holding portion with the reflecting surface facing the display surface of the display device, the reflecting surface being configured to reflect the image to an eyeball of the user; and
a shielding portion configured to shield a space accommodating the display device and the reflecting member.

2. The head mounted display according to claim 1, wherein the reflecting member is placed in front of a face of the user equipped with the mounting member.

3. The head mounted display according to claim 1, wherein the reflecting member is held on the holding portion with a surface, opposite to the reflecting surface, abutting against the holding portion.

4. The head mounted display according to claim 1, wherein the display device is held in a portion of the holding portion, which is located above the head of the user equipped with the mounting member.

5. The head mounted display according to claim 1, wherein the shielding portion surrounds an occipital region of the user equipped with the mounting member.

6. The head mounted display according to claim 1, wherein the shielding portion covers a part of a side end of the mounting member.

7. The head mounted display according to claim 1, wherein the holding portion is provided with a weighting member for positioning a center of gravity of the head mounted display in a region located more to a parietal region of the user equipped with the mounting member than a portion holding the display device.

8. The head mounted display according to claim 1, further comprising a lens that is interposed between the display device and the reflecting member and magnifies the image.

9. The head mounted display according to claim 1, further comprising a sensor that acquires position and orientation information of the head mounted display,
wherein the display device displays an image corresponding to the position and orientation information.

10. A head mounted display, comprising:
a holding portion;
a display device including a display surface that displays an image; and a holding surface held on the holding portion;
a reflecting member including a reflecting surface, the reflecting member being held on the holding portion with the reflecting surface facing the display surface of the display device; and
a shielding portion that shields a space accommodating the display device and the reflecting member.
